(19) United States
(12) Patent Application Publication
(10) Pub. No.: US 2017/0233964 A1
(43) Pub. Date: Aug. 17, 2017

(54) HIGHLY COMPACTED LEAF BALES FOR USE AS EROSION CONTROL BERM AND METHODS OF USING SAME

(71) Applicant: Nicholas Vene, Jersey City, NJ (US)

(72) Inventor: Nicholas Vene, Jersey City, NJ (US)

(21) Appl. No.: 15/429,612

(22) Filed: Feb. 10, 2017

Related U.S. Application Data
(60) Provisional application No. 62/294,409, filed on Feb. 12, 2016.

(51) Int. Cl. E02B 3/10; B30B 9/30; E02B 3/14

(52) U.S. Cl. CPC E02B 3/106; E02B 3/14; B30B 9/3021

(57) ABSTRACT

High-density bales for erosion control or for forming a flood barrier are made by the compaction of tree leave material. The bales are made substantially from tree leave material that retains at least a portion of the vein structure. The vein structure improves the structurally integrity of the bale. A baler may be used to form the bale and it may compact the leave material up to an 8:1 compaction ratio, forming bales with a density of 0.3 to 0.8g/cc or more. The bales may have a retainer wire or mesh configured around a portion of the bale to retain the bale shape. The bales may contain seeds for growing plants directly from the bales as the leave material degrades to provide the nutrients for plant growth. This plant growth from the bale provides an aesthetically appealing bale that blends into the natural environment.

### CROSS REFERENCE TO RELATED APPLICATIONS

This application claims the benefit of priority to U.S. provisional patent application 62/294,409, filed on Feb. 12, 2016; the entirety of which is hereby incorporated by reference herein.

### BACKGROUND OF THE INVENTION

Field of the Invention

The invention relates to bales and particularly bales for erosion control and flood mitigation made of tree leaf material.

Background

There has been an increase in flooding through the united states, perhaps in part due to global climate changes. Communities have to quickly erect barriers to prevent damage from the rising flood waters. In many cases, concrete barriers are aligned and/or sand bags are stacked in attempts to form a flood barrier wall. These temporary storm walls can be difficult to construct in time to prevent damage to structures and obtaining the materials, concrete barriers and/or sand bags can be a challenge. In addition, the barrier materials are heavy and difficult to move and place in the required areas in time. Furthermore, these non-natural barrier materials have to be removed after the flood waters have receded as they are not attractive. Barrier walls made of concrete blocks used to prevent erosion are not attractive and detract from the natural beauty where they are often placed, such as along creek, river or streams.

### SUMMARY OF THE INVENTION

The invention is directed to a high-density bale comprising compacted tree leave material. These high-density bales may be used for erosion control or to form a flood barrier wall. The high-density bales may have a retaining wire or mesh configured around the bale to provide additional support. The retaining wire or mesh may extend around the length, width and/or height axis of the high-density bale. These high-density bales may be more aesthetically appealing as they may blend into the natural landscape better than concreate or metal barrier walls or blocks. In addition, an exemplary high-density bale may be used to grow vegetation or plants, such as grasses, vines, shrubs and/or trees from the bale. Seeds, such as seeds not derived from the compacted tree leave material, may be placed into the high-density bale and the natural degradation of the leave material over time, combine with the addition of water (by rain or by intentional watering) may provide the proper nutrients to support the growth of the vegetation. Vegetation growing from the high-density bale may further improve the aesthetic appeal of the bale wherein the bale blends into the natural environment.

Exemplary leave material used in the high-density bale has at least a portion of an original vein structure. Tree leaves from deciduous trees have veins that interconnect to form vein structures. These vein structures have been found to reinforce a bale may substantially of tree leave material, such as at least 80% tree leave material. As tree leaves degrade or decompose the veins and vein structure may be retained for a period of time, such as before the completion of a thermophilic phase of composting. Tree leave material having at least a portion of an original vein structure has identifiable veins that retain their shape and have some structural integrity. An exemplary high-density bale may consist essentially of compacted tree leave material having at least a portion of an original vein structure, wherein at least 85% of the bale by weight is said compacted tree leave material, or preferably at least 90% of the bale by weight is said compacted tree leave material, and even more preferably at least 95% of the bale by weight is said compacted tree leave material. The more leave material with original vein structure, the higher the strength and integrity of the bale. The tree leaves consist essentially of leaves from deciduous trees, wherein the leave material is 90% or more, or even 95% or more leave material from deciduous trees.

A retaining wire, such as baling wire, or a mesh may be configured around a portion of the high-density bale. The wire or mesh may extend around the length axis, width axis and/or height axis of the high-density bale and may form a loop that provides support to retain the bale shape. The length axis extends along the length of the bale and is centrally located on the sides. The width axis extends along the width of the bale and is centrally located on the front and back surfaces of the bale. The height axis extends along the height of the bale and is centrally located on the bottom and top surfaces of the bale.

A retaining wire may be metal or comprise a natural material, or a synthetic material, such as rope or cord comprising natural or synthetic materials. A mesh may be a metal mesh or may comprise a natural or synthetic material, such as a woven fabric, a perforated fabric and the like. A retaining wire or mesh may be biodegradable, wherein the wire or mesh degrades over time.

A mesh comprises strands that form open areas between the strands. A mesh may have a percent open area, or planar area of the mesh made up of the openings, of about 50% or more, or about 75% or more, or about 85% or more and any range between and including the percentages provided. The openings have an opening dimension which may be at least about 0.5 cm, or at least about 1.0 cm, or at least about 2.0 cm. The openings may be configured to allow a plant, such as grass or a shrub to grow therethrough. The mesh may be flexible to allow the plant to grow through the opening in the mesh.

As exemplary high-density bale comprises non-compacted tree leave derived seeds retained in the high-density bale. The non-compacted tree leave derived seeds are seeds that are not from the tree leaf material, rather, they are seeds that are added to the bale (either before, during or after the baling process) for the purposes of growing vegetation that may be different from the tree from which the tree leave material is derived. These non-compacted tree leave derived seeds may, preferably, be mixed with and randombly dispersed through the tree leave material before or while the material is inserted into a baling machine or compactor. Ideally a random dispersion of seeds will allow for a somewhat even or uniform dispersion of seeds within the bale. Alternatively, seed material can be added to the compacted bales whereby seeds are inserted or otherwise added into the compacted bale. Seeds located at a certain depth from one or more of the surfaces will be capable of germinating and growing a plant, such a grass, vines, flowers, shrubs or trees, for example. The seeds located at a depth of no more than about 15cm and preferably no more than about 10 cm from a bale surface will allow for proper germination and growth. For seeding post-baling, the seeds may optionally be place solely on one surface of the bale, such as on the top surface or on a plurality of surface. In one embodiment, the seeds are vine seeds that produce a vine that grows and substantially covers the exposed surfaces of the bale. The seeds include, but are not limited to, grass seeds, vine seeds, flower seeds, shrub seeds, vegetable seeds or trees seeds.

An exemplary high-density bale has a length, width and height that are all at least 75 cm, and may be as large as 200 or even 250 cm. The high-density bale may have a density of at least a 0.30 g/cc or more, preferably at least about 0.6 g/cc or more and even more preferably at least about 0.8 g/cc or more and any range between and including the density values provided.

An exemplary high-density bale may be made by gathering tree leaves, such as tree leaves that have fallen from deciduous trees. A substantial portion of this leave material may maintain at least a portion of an original vein structure, as described herein. The leave material may then be formed into a bale, such as by utilizing a baling apparatus. A single-ram baling apparatus may be preferred due to the lofty nature of the leave material. A single-ram baling apparatus may result in less jamming due to the improved volume control over dual-ram compacted tree leavers. The leave material may be compacted to a compact ratio of about 6:1 or more, or about 8:1 or more to achieve good berm strength. The higher the compaction the more structural integrity the bale may have. A retaining wire or mesh may be configured around the bale. Non-compacted tree leave derived seeds may be configured in the bale, either prior to forming the bale, or after the bale is formed. When the seeds are placed into the bale after the baling step, they may be positioned at a desired depth from one or more of the surfaces. The high-density bales may be place next to each other, with surfaces contacting each other to form a barrier wall for erosion or as a flood barrier. A plurality of bales may be held together by straps or other retaining devices to secure a barrier wall.

### EXAMPLE

High-density bales were made from tree leave material utilizing a Bollergraff Model 100-140 compacted tree leaver that was modified to compacted tree leave the vegetative material. High-density bales having dimensions of about 42-48 inch wide by 42-48 inch high by 60-80 inches long were made and had a weight of about 2500 to 4000 pounds. Each of the high-density bales had about 6 to 8 cubic yards of tree leave material.

The summary of the invention is provided as a general introduction to some of the embodiments of the invention, and is not intended to be limiting. Additional example embodiments including variations and alternative configurations of the invention are provided herein.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective view of an exemplary high-density bale comprising compacted leave material having a portion of an original vein structure and retaining wire extending around the length axis and around the width axis.

FIG. 2 shows a tree leaf having a vein structure of a plurality of veins.

FIG. 3 shows a cross-sectional view of an exemplary high-density bale having non-compacted tree leave derived seeds in the high-density bale at a depth from the outer surface.

FIG. 4 shows a perspective view of an exemplary high-density bale comprising grass and shrubs growing from the high-density bale.

FIG. 5 shows a perspective view of an exemplary high-density bale having a wire mesh configured around the outside surface.

FIG. 6 shows a top view of an exemplary mesh having openings between strands.

FIG. 7 shows a perspective view of a flood mitigation barrier for a pavilion comprising a plurality of high density bales configured next to each other to from a barrier wall.

FIG. 8 shows a top view of a flood mitigation barrier for a pavilion comprising a plurality of high density bales configured next to each other to from a barrier wall.

FIG. 9 shows a perspective view of a baler, a single arm baler, that can be used to compact the tree leave material into high-density bales.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

### Definitions:

A tree leaf, as used herein, is a leaf from a deciduous tree.

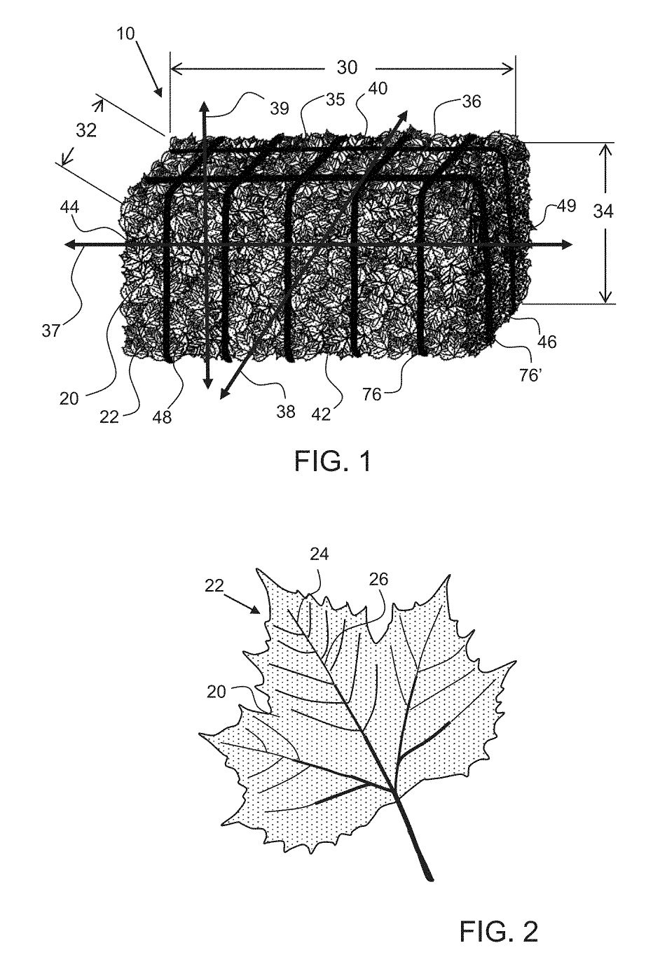

As shown in FIG. 1, an exemplary high-density bale 10 comprises compacted leave material 20 having a portion of an original vein structure and retaining wire 76 extending around the length axis 37 and around the width axis 49 of the high-density bale. The high-density bale is rectangular shaped, having a length 30 from left side 44 to the right side 46, a width 32 from the front side 48 to the back side 49 and a height 34 from the bottom 42 to the top 40 of the bale. A high-density bale may have planar surfaces 36, such as the top, bottom, sides, front and back, and may form a cube or rectangular shaped three-dimensional shape, as shown, wherein the length is greater than the width and height. The retaining wire 76, such as baling wire, extends around the outside surface 35 of the bale to form a loop to retain the compacted tree leaf material.

As shown in FIG. 2, an exemplary tree leaf 22, such as a maple leaf as shown, has a vein structure 26 formed from a plurality of veins 24. The veins form an interconnected network that is important for retaining a compacted form of the high-density bale. Tree leaf material 20 comprises tree leaves having at least a portion of a vein structure, wherein the vein structure is still intact to form said interconnected networks.

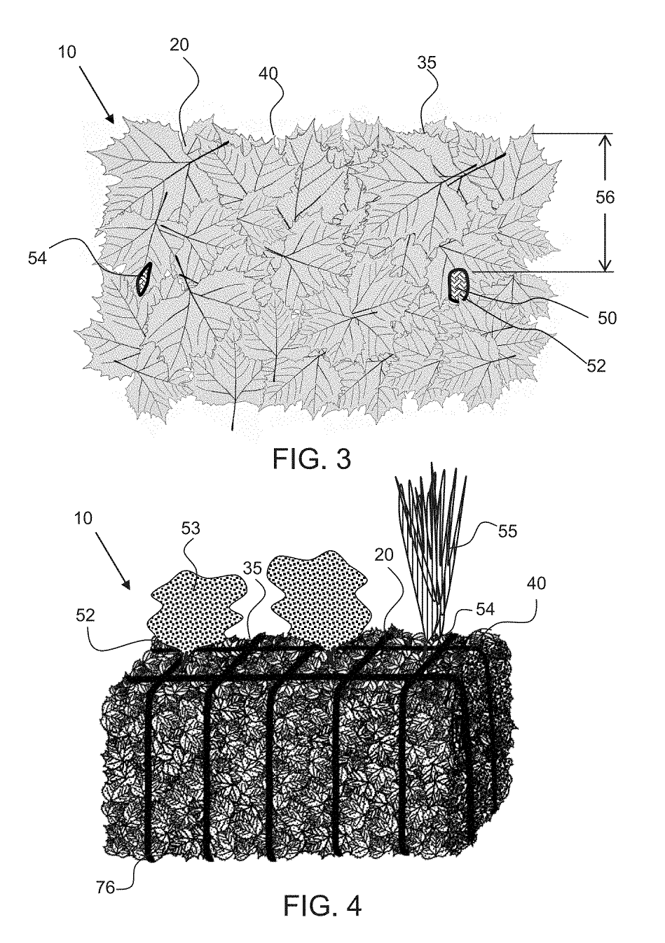

As shown in FIG. 3, an exemplary high-density bale 10 has non-compacted tree leave derived seeds 50 in the high-density bale at a depth 56 from the outside surface 35. A grass seed 54 and a shrub seed 52 are shown being placed at a depth suitable to allow germination and growth of a grass or shrub, respectively, from the high-density bale. The tree leave material 20 may provide proper conditions and nutrients, as it decays, for the growth of the grass or shrub. The non-compacted tree leave derived seeds 50 may be preferably positioned at a depth 56 from the top surface 40 of the high-density bale.

As shown in FIG. 4, an exemplary high-density bale 10 comprises a grass 55 and shrubs 53 growing from the high-density bale. The non-compacted tree leave derived seeds 50, the grass seed 54 and the shrub seeds 52, produced the grass and shrub growing from the high-density bale. The growth of grass, shrubs or even trees from tree seeds that are non-compacted tree leave derived seeds, may produce a more aesthetically appealing high-density bale.

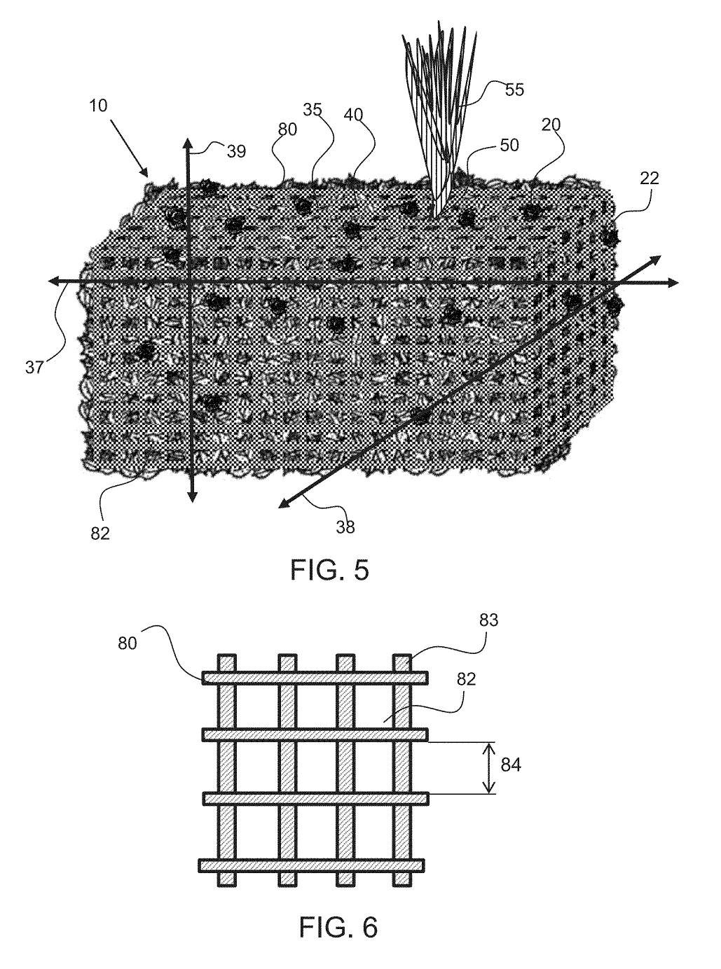

As shown in FIG. 5, an exemplary high-density bale 10 has a wire mesh configured around the outside surface 35 of the bale. The wire mesh has openings 82 that exposes the compacted tree leave material 20 of the high-density bale and allows growth of grass 55 or shrubs therethrough. A wire mesh may have a percent open area of about 50% or more and more preferably about 75% or more.

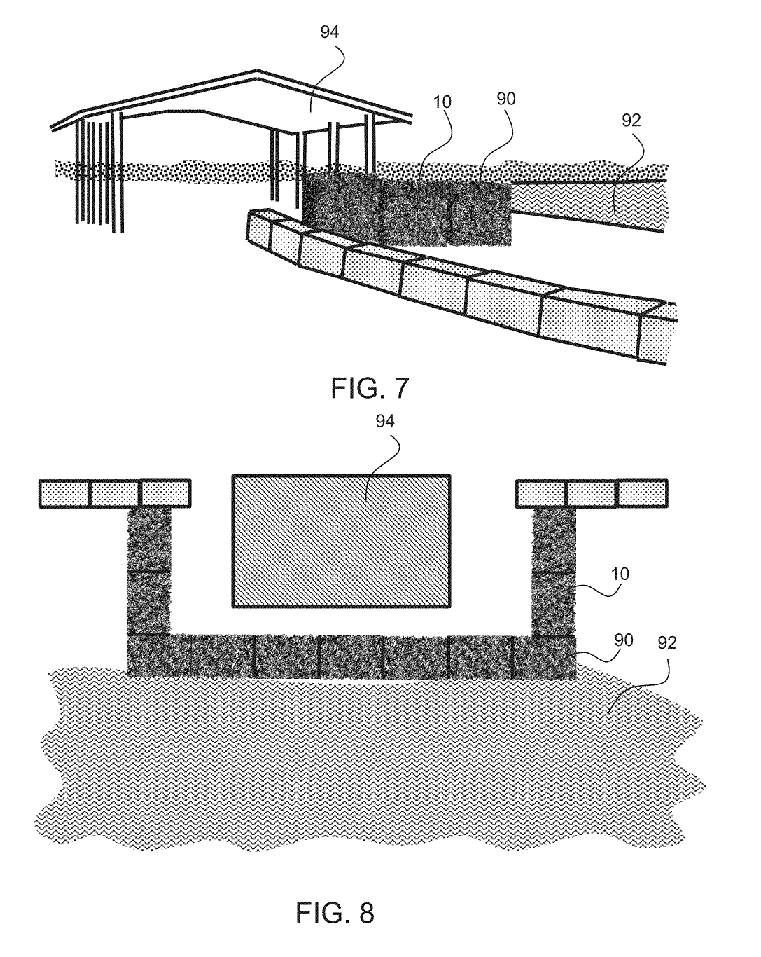

As shown in FIG. 6, an exemplary wire mesh 80 has a plurality of strands 83 that are interconnected to from said mesh and openings 82 in the mesh. The openings have an opening dimension 84 which may be at least about 0.5 cm, or at least about 1.0 cm, or at least about 2.0 cm. The mesh has a percent open area, or the percentage of the planar surface of the mesh made up of openings that is at least 50%, as shown in FIG. 6.

FIGS. 7 and 8 show a flood mitigation barrier for a structure 94, a pavilion, comprising a plurality of high density bales 10 configured next to each other to from a barrier wall 90. The flood water 92 is retained by the barrier wall 90.

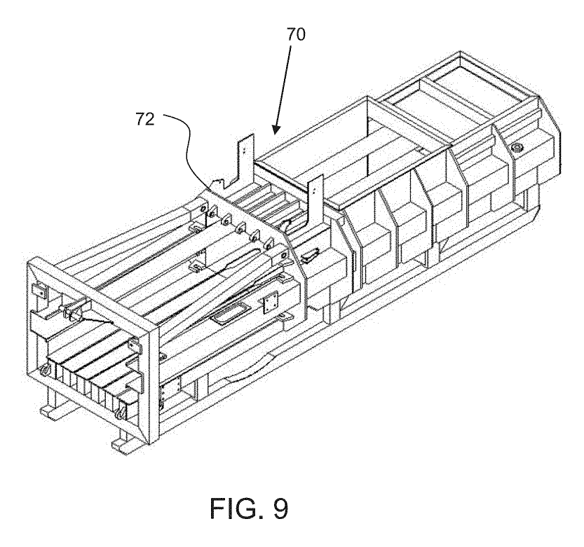

Baling machines (“balers”) are used to bale waste and other compressible materials, such as for transporting waste material to a disposal site. FIG. 9 shows an exemplary baler 70, a single arm baler 72, as described herein. With respect to the present invention, a baler is used to compact the tree leave material into the high-density bales for later utilization, as opposed to disposal. Notably, most leaf-collection efforts focus upon disposal, not leaf utilization. Leaf disposal often involves composting or biodegradation of the collected leaves, which requires a certain amount of circulation of oxygen through the tree leave material. In composting, creating static compaction of organic material is undesirable. Thus, it is difficult to find any teaching in the prior art about optimal techniques for leaf compaction.

In connection with the development of this invention, it was determined that tree leave material frequently causes jamming in certain common balers/compactors. It has been determined that a baler with a single, automated arm (i.e., a bar, ram or platen) is useful to limit the amount of jamming that otherwise occurs with leaf material in multi-arm balers/compactors. As disclosed in U.S. Pat. No. 7,493,854, in a conventional “horizontal” baler, the material to be baled is typically moved along a conveyor that dumps (i.e., gravity feeds) the material down a chute and into a receiving (i.e., charging or loading) chamber. In single-ram embodiment of a horizontal baler, a ram powered by a hydraulic cylinder moves the material into a compression chamber and compresses the material therein. Often, a shear bar located at the entrance of the compression chamber shears off excess material extending into the chute as the ram advances the material into the compression chamber. Once the material has attained a sufficient degree of compression, bale tie wires are wrapped around the material to form a bale. During the baling process, loose material (like leaves) is especially susceptible to falling behind or otherwise becoming jammed between the ram and the shear bar. For machines that utilize a dual or second ram to feed the material into the receiving chamber there is again a heightened potential for jamming when loose material gets positioned between or behind these rams. For this reason, the present invention is directed to a single-ram baler, which minimizes the potential for jamming. Similarly, eliminating a shear bar may reduce the potential for unwanted baler jamming.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A high-density bale comprising:
a) compacted tree leave material having at least a portion of an original vein structure;
b) a length;
c) width;
d) height;
e) a weight;
f) an outside surface; and
g) a density.

2. The high-density bale of claim 1, wherein the high-density bale consists essentially of compacted tree leave material having at least a portion of an original vein structure, wherein at least 80% of the bale by weight is said compacted tree leave material.

3. The high-density bale of claim 1, wherein the high-density bale consists essentially of compacted tree leave material having at least a portion of an original vein structure, wherein at least 95% of the bale by weight is said compacted tree leave material.

4. The high-density bale of claim 1, wherein the high-density bale consists essentially of compacted tree leave material that has not completed a thermophilic phase of decomposition.

5. The high-density bale of claim 1, further comprising non-compacted tree leave derived seeds retained in the high-density bale.

6. The high-density bale of claim 5, wherein vegetative growth has germinated from the non-compacted tree leave derived seeds along one or more outside surfaces of the bale.

7. The high-density bale of claim 5, wherein the non-compacted tree leave derived seeds are randomly dispersed throughout the bale.

8. The high-density bale of claim 5, wherein the non-compacted tree leave derived seeds are shrub seeds.

9. The high-density bale of claim 5, wherein the non-compacted tree leave derived seeds are grass seeds.

10. The high-density bale of claim 1, wherein the length, width and height are all at least 75 cm.

11. The high-density bale of claim 1, wherein the density is at least 0.30 g/cc.

12. The high-density bale of claim 1, further comprising a lacing pattern of baling wire configured around the high-density bale.

13. The high-density bale of claim 12, wherein the lacing patter comprising baling wire extending around a length axis of the bale and around a width axis of the bale.

14. The high-density bale of claim 1, further comprising a wire mesh extending around at least one of the length axis, width axis or height axis of the high-density bale.

15. The high-density bale of claim 1, wherein the wire mesh has an open area of at least 75 %.

16. A method of creating a flood mitigation bale from leaf material comprising:
a) collecting tree leaves prior to the leaves completing a thermophilic phase of composting, wherein the leaves maintain at least a portion of an original vein structure;
b) inserting said collected tree leaves into a baling apparatus;
c) compacting said tree leaves with the baling apparatus to form a high-density bale of compacted tree leave material having at least a portion of an original vein structure;
wherein said high-density bale has a length, width and height of at least 75 cm and a density of at least 0.3 g/cc.

17. The method of creating a flood mitigation bale from leaf material of claim 16, further comprising the steps of;
a) providing a wire mesh;
b) wrapping the compacted tree leaves in the wire-mesh exterior around at least one of the length axis, width axis or height axis of the high-density bale.

18. The method of creating a flood mitigation bale from leaf material of claim 16, wherein the baling apparatus is a single-ram baling apparatus.

19. The method of creating a flood mitigation bale from leaf material of claim 16, further comprising the steps of:
a) providing non-compacted tree leave derived seeds;
b) inserting said non-compacted tree leave derived seeds into the high-density bale.

20. The method of creating a flood mitigation bale from leaf material of claim 19, wherein the non-compacted tree leave derived seeds are randomly dispersed throughout the bale.

21. The method of creating a flood mitigation bale from leaf material of claim 16, further comprising the step of configuring a plurality of said high-density bales next to each other to form a flood mitigation barrier.
